(19) United States
(12) Patent Application Publication
(10) Pub. No.: US 2025/0065687 A1
(43) Pub. Date: Feb. 27, 2025

(54) HEATING DEVICE AND ELECTRIC VEHICLE

(71) Applicant: AISAN KOGYO KABUSHIKI KAISHA, Obu-shi (JP)

(72) Inventor: Yoichi NAKAO, Toyokawa-shi (JP)

(21) Appl. No.: 18/796,676

(22) Filed: Aug. 7, 2024

(30) Foreign Application Priority Data
Aug. 24, 2023 (JP) 2023-136406

(51) Int. Cl. B60H 1/00

(52) U.S. Cl. CPC B60H 1/00021; B60H 2001/00092; B60H 2001/00128; B60H 2001/00135

(57) ABSTRACT

A heating device may include: a heater; an upper surface-side member facing an upper surface of the heater; and a lower surface-side member facing a lower surface of the heater; and an upper surface-side passage defined between the heater upper surface and the upper surface-side member; and a lower surface-side passage defined between the heater lower surface and the lower surface-side member; and a first spacer disposed between the heater upper surface and the upper surface-side member to secure a space between the heater upper surface and the upper surface-side member; and the upper surface-side member; and a second spacer disposed between the heater lower surface and the lower surface-side member to secure a space between the heater lower surface and the lower surface-side member; and an elastic member pressing the upper surface-side member or the lower surface-side member toward the heater.

### REFERENCE TO RELATED APPLICATIONS

This application claims priority from Japanese Patent Application No. 2023-136406 filed on Aug. 24, 2023. The entire content of the priority application is incorporated herein by reference.

### TECHNICAL FIELD

The art disclosed herein relates to a heating device and an electric vehicle.

### BACKGROUND

Japanese Patent Application Publication No. H10-189228 describes a ceramic heater unit including a plate-shaped ceramic heater, two metal members that sandwich the ceramic heater from both sides tightly in direct contact with the ceramic heater, and sealing means that waterproofs the ceramic heater so that heated liquid makes contact with only the two metal members but does not make contact with the ceramic heater.

### SUMMARY

In the ceramic heater unit of Japanese Patent Application Publication No. H10-189228, for example, warpage or expansion of the ceramic heater may occur when the ceramic heater generates heat. When such warpage or expansion occurs in the ceramic heater, a width of a passage of the heated liquid (heat medium) may fluctuate due to the effect of the warpage or expansion.

The present teachings provide a technique that allows to suppress fluctuation in the width of heat medium passage.

In a first aspect of the present teachings, a heating device may comprise: a heater; an upper surface-side member facing an upper surface of the heater; and a lower surface-side member facing a lower surface of the heater; and an upper surface-side passage defined between the upper surface of the heater and the upper surface-side member; and a lower surface-side passage defined between the lower surface of the heater and the lower surface-side member; and a first spacer disposed between the upper surface of the heater and the upper surface-side member to secure a space between the upper surface of the heater and the upper surface-side member; and the upper surface-side member; and a second spacer disposed between the lower surface of the heater and the lower surface-side member to secure a space between the lower surface of the heater and the lower surface-side member; and an elastic member pressing the upper surface-side member or the lower surface-side member toward the heater.

According to this configuration, by the elastic member being used to press the upper surface-side member or the lower surface-side member toward the heater, even if warpage and/or expansion of the heater occurs for example when the heater generates heat, they can be corrected. Due to this, the width of the passage of the heat medium can be suppressed from fluctuating due to the effect of warpage and/or expansion of the heater.

In a second aspect of the present teachings, in the above-described first aspect, the heater may be spirally shaped. The first spacer may extend in a radial direction of the spirally-shaped heater between the upper surface of the heater and the upper surface-side member. The second spacer may extend in the radial direction of the spirally-shaped heater between the lower surface of the heater and the lower surface-side member.

According to this configuration, the heat medium can be allowed to flow smoothly in the radial direction of the spirally-shaped heater, and fluctuation in a flow speed of the heat medium can be suppressed.

In a third aspect of the present teachings, in the above-described first aspect, the heater may be linearly shaped. The first spacer may extend in a short length direction of the linearly-shaped heater between the upper surface of the heater and the upper surface-side member. The second spacer may extend in the short length direction of the linearly-shaped heater between the lower surface of the heater and the lower surface-side member.

According to this configuration, the heat medium can be allowed to flow smoothly in the short length direction of the linearly-shaped heater, and fluctuation in the flow speed of the heat medium can be suppressed.

A fourth aspect of the present teachings may be an electric vehicle comprising one of the heating devices according to the above first to third aspects. According to this configuration, accuracy of temperature control of the heat medium used in the electric vehicle can be improved.

### BRIEF DESCRIPTION OF DRAWINGS

FIG. 1 illustrates a vertical cross-sectional view of a heating device according to an embodiment.

FIG. 2 illustrates a lateral cross-sectional view of the heating device according to the embodiment (cross-sectional view along II-II in FIG. 1).

FIG. 3 illustrates an enlarged view of a section III in FIG. 1.

FIG. 4 illustrates a perspective view of an elastic member according to the embodiment.

FIG. 5 illustrates a lateral cross-sectional view of a heating device according to a variant.

FIG. 6 illustrates a lateral cross-sectional view of a heating device according to another variant.

### DETAILED DESCRIPTION

### Embodiment

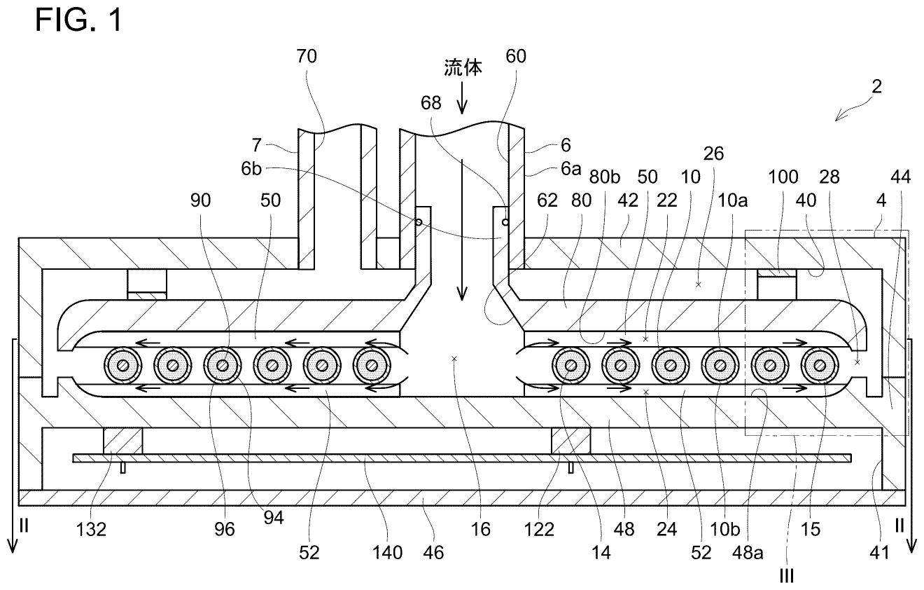

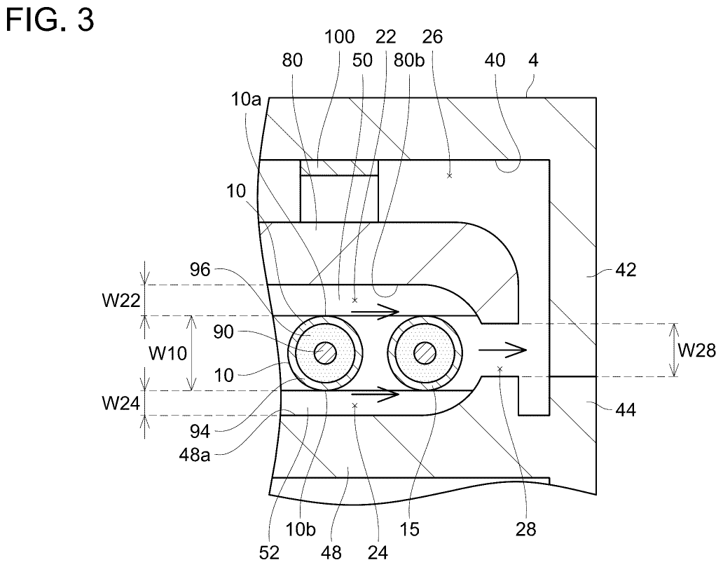

A heating device 2 according to an embodiment will be described with reference to drawings. As illustrated in FIGS. 1 to 3, the heating device 2 comprises a heater 10, a pressing member 80, an elastic member 100, and a casing 4. The heater 10, the pressing member 80, and the elastic member 100 are housed inside the casing 4. The heating device 2 also comprises an intake tube 6 (first intake tube 6a and second intake tube 6b) configured to introduce fluid into the casing 4 and a discharge tube 7 configured to discharge the fluid out of the casing 4. The fluid introduced into the casing 4 is, for example, water or coolant fluid. The fluid introduced into the casing 4 serves as a heat medium for the heating device 2.

### (Configuration of Heaters 10)

The heater 10 is an electric heater configured to generate heat when energized. The heater 10 is, for example, a sheathed heater or a ceramic heater. The heater 10 comprises, for example, a heating element 90, a tubular casing 94 that houses the heating element 90, and a powdery insulating material 96 that is filled into a gap between the heating element 90 and the casing 94. The heating element 90 is composed of, for example, a helical nichrome wire.

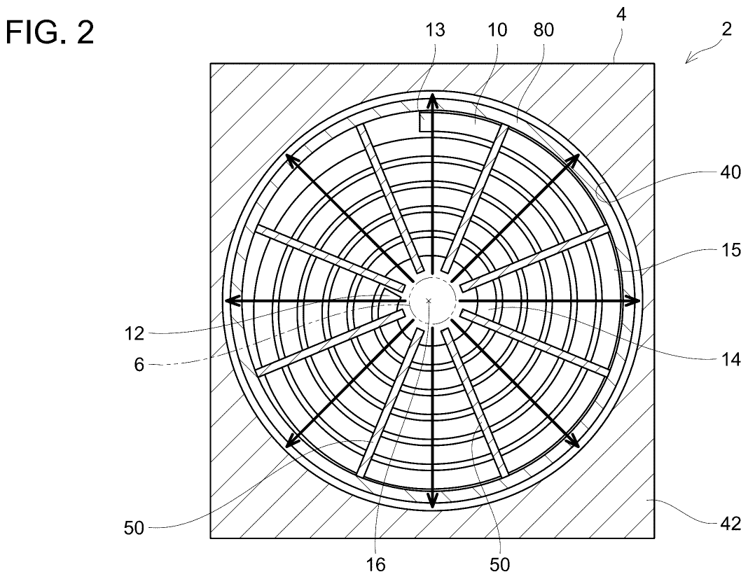

The heater 10 is spirally shaped in a top view of the heater 10. The spirally-shaped heater 10 comprises an inner end 12 and an outer end 13 in a spiral direction. The inner end 12 and outer end 13 are connected to electrical terminals 122 and 132 (see FIG. 2) for supplying power, respectively. The heater 10 is powered through the electrical terminals 122 and 132. Each of plural revolving portions of the spirally-shaped heater 10 makes an entire revolution in the spiral direction of the heater 10. For example, each of an innermost circumferential portion 14 and an outermost circumferential portion 15 of the heater 10 makes an entire revolution in the spiral direction of the heater 10.

### (Configuration of Pressing Member 80)

The pressing member 80 is positioned inside the casing 4 such that the pressing member 80 covers an upper surface 10a of the heater 10. The pressing member 80 is configured in a substantially-disk shape so as to cover the upper surface 10a of the spirally-shaped heater 10. The pressing member 80 extends in a radial direction of the spirally-shaped heater 10. The pressing member 80 is arranged movably up and down between the heater 10 and the casing 4. The pressing member 80 faces the upper surface 10a of the heater 10 and extends in a lateral direction along the upper surface 10a of the heater 10.

An upper surface-side passage 22 is defined between the upper surface 10a of the heater 10 and a lower surface 80b of the pressing member 80. The upper surface-side passage 22 extends in the lateral direction along the upper surface 10a of the heater 10. The upper surface-side passage 22 extends in the radial direction of the spirally-shaped heater 10. The upper surface-side passage 22 is a passage through which the fluid flows in the lateral direction along the upper surface 10a of the heater 10. The upper surface-side passage 22 is a passage through which the fluid flows in the radial direction of the heater 10.

A width W22 of the upper surface-side passage 22 in a vertical direction is narrower than, for example, three times a width W10 (=3×W10) in the vertical direction of the heater 10. The width W22 of the upper surface-side passage 22 in the vertical direction may be narrower than, for example, twice the width W10 (=2×W10) in the vertical direction of the heater 10. The width W22 of the upper surface-side passage 22 in the vertical direction may be narrower than, for example, the width W10 in the vertical direction of the heater 10.

A plurality of first spacers 50 is disposed on the lower surface 80b (surface closer to the heater 10) of the pressing member 80. The plurality of first spacers 50 is arranged between the lower surface 80b of the pressing member 80 and the upper surface 10a of the heater 10. The plurality of first spacers 50 is fixed to the lower surface 80b of the pressing member 80. The plurality of first spacers 50 extends radially in the radial direction of the spirally-shaped heater 10. The plurality of first spacers 50 is arranged at intervals in a circumferential direction of the spirally-shaped heater 10. Each first spacer 50 secures a space between the upper surface 10a of the heater 10 and the lower surface 80b of the pressing member 80. Thereby, each first spacer 50 secures the vertical width of the upper surface-side passage 22. The pressing member 80 presses the heater 10 downward via the plurality of first spacers 50.

### (Configuration of Casing 4)

The casing 4 comprises a first housing section 40 that houses the heater 10, the pressing member 80, and the elastic member 100, etc. The casing 4 also comprises a second housing section 41 that houses a circuit board 140 and the electrical terminals 122, 132, etc.

The casing 4 comprises an upper member 42 facing the pressing member 80, a lower member 44 facing the heater 10, and a cover member 46 facing the lower member 44. The first housing section 40 is defined in a portion enclosed by the upper member 42 and the lower member 44. The second housing section 41 is defined in a portion enclosed by a lower surface-side member 48 and the cover member 46.

An outer passage 26 is defined between the upper member 42 of the casing 4 and the pressing member 80. The outer passage 26 extends in the lateral direction along the pressing member 80. The outer passage 26 extends in the radial direction of the spirally-shaped heater 10. The outer passage 26 is a passage through which the fluid flows in the lateral direction along the pressing member 80. The outer passage 26 is a passage through which the fluid flows in the radial direction of the spirally-shaped heater 10.

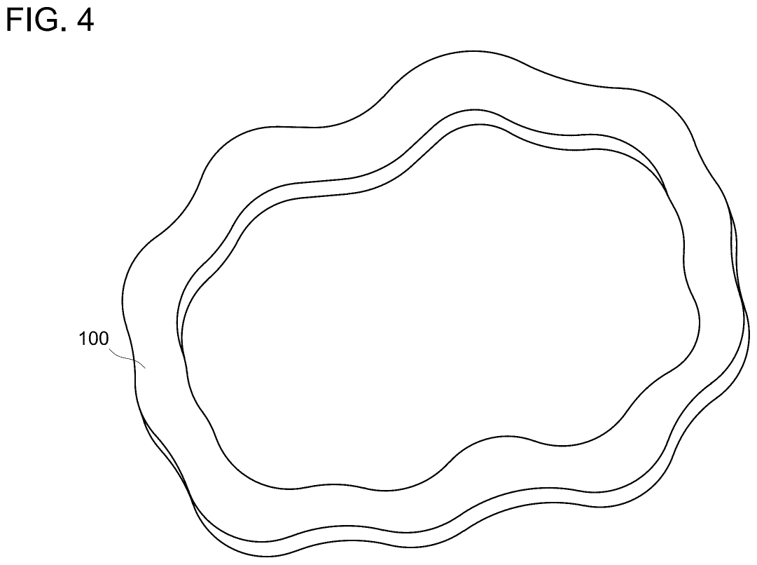

The elastic member 100 is arranged in the outer passage 26 between the upper member 42 and the pressing member 80. As illustrated in FIG. 4, the elastic member 100 is composed of a ring-shaped wavy plate-like member. The elastic member 100 is constituted of metal, for example. The elastic member 100 is arranged to surround the intake tube 6. The elastic member 100 extends in the circumferential direction of the heater 10. The elastic member 100 functions as a leaf spring that presses the pressing member 80. An upper end of the elastic member 100 is in contact with the upper member 42 of the casing 4, and a lower end of the elastic member 100 is in contact with the pressing member 80. The elastic member 100 presses the pressing member 80 toward the heater 10 by reaction force of the upper member 42 of the casing 4. This causes the pressing member 80 to press the heater 10 downward.

The configuration of the elastic member 100 is not specifically limited. For example, the elastic member 100 may be composed of a coil spring. The elastic member 100 may be constituted of rubber. The number of elastic member(s) 100 is not particularly limited. A plurality of elastic members 100 (e.g., coil springs) may be arranged at intervals in the circumferential direction of the heater 10.

The lower member 44 of the casing 4 comprises the lower surface-side member 48 that faces the lower surface 10b of the heater 10. The lower surface-side member 48 is arranged to cover the lower surface 10b of the heater 10. The lower surface-side member 48 is configured in a substantially-disk shape so as to cover the lower surface 10b of the spirally-shaped heater 10. The lower surface-side member 48 extends in the radial direction of the spirally-shaped heater 10. The lower surface-side member 48 extends in the lateral direction along the lower surface 10b of the heater 10.

A lower surface-side passage 24 is defined between the lower surface 10b of the heater 10 and an upper surface 48a of the lower surface-side member 48. The lower surface-side passage 24 extends in the lateral direction along the lower surface 10b of the heater 10. The lower surface-side passage 24 extends in the radial direction of the spirally-shaped heater 10. The lower surface-side passage 24 is a passage through which the fluid flows in the lateral direction along the lower surface 10b of the heater 10. The lower surface-side passage 24 is a passage through which the fluid flows in the radial direction of the heater 10.

A width W24 of the lower surface-side passage 24 in the vertical direction is narrower than, for example, three times the vertical width W10 (=3×W10) of the heater 10. The width W24 of the lower surface-side passage 24 in the vertical direction may be narrower than, for example, twice the width W10 (=2×W10) in the vertical direction of the heater 10. The width W24 of the lower surface-side passage 24 in the vertical direction may be narrower than, for example, the width W10 in the vertical direction of the heater 10.

A plurality of second spacers 52 is disposed on the upper surface 48a (surface closer to the heater 10) of the lower surface-side member 48. The plurality of second spacers 52 is arranged between the upper surface 48a of the lower surface-side member 48 and the lower surface 10b of the heater 10. The plurality of second spacers 52 is fixed to the upper surface 48a of the lower surface-side member 48. The plurality of second spacers 52 extends radially in the radial direction of the spirally-shaped heater 10. The plurality of second spacers 52 is arranged at intervals in the circumferential direction of the spirally-shaped heater 10. Each second spacer 52 secures a space between the lower surface 10b of the heater 10 and the upper surface 48a of the lower surface-side member 48. Due to this, each second spacer 52 secures the vertical width of the lower surface-side passage 24.

A connecting passage 28 is defined between an outer end of the lower surface-side member 48 and an outer end of the pressing member 80. The connecting passage 28 is defined around the outermost circumferential portion 15 of the heater 10 and surrounds the outermost circumferential portion 15 of the heater 10. The connecting passage 28 is located on an outer side of the outermost circumferential portion 15 of the heater 10 in the radial direction of the heater 10. The connecting passage 28 is defined between the outermost circumferential portion 15 of the heater 10 and the outer passage 26. The connecting passage 28 extends along the outermost circumferential portion 15 of the heater 10 in the circumferential direction of the outermost circumferential portion 15. The connecting passage 28 is in communication with the upper surface-side passage 22 and the lower surface-side passage 24. The connecting passage 28 is a passage through which the fluid, which flowed through the upper surface-side passage 22 and the lower surface-side passage 24, flows to the outer passage 26.

A width W28 of the connecting passage 28 in the vertical direction is narrower than, for example, the vertical width W10 of the heater 10 and narrower than a width W50 of the outer passage 26 in the vertical direction. The width W28 of the connecting passage 28 in the vertical direction may be narrower than the width W22 of the upper surface-side passage 22 in the vertical direction and narrower than the width W24 of the lower surface-side passage 24 in the vertical direction.

### (Configuration of Intake Tube 6 (First Intake Tube 6a and Second Intake Tube 6b) and Discharge Tube 7)

As illustrated in FIG. 1, the first intake tube 6a of the heating device 2 is connected to the upper member 42 of the casing 4. A downstream end of the first intake tube 6a is fixed to the upper member 42 of the casing 4. The first intake tube 6a extends vertically upward from the upper member 42 of the casing 4. The first intake tube 6a may be fabricated integrally with the casing 4. The first intake tube 6a comprises an intake passage 60 for introducing the fluid into the casing 4.

The second intake tube 6b is connected to the pressing member 80. A downstream end of the second intake tube 6b is fixed to the pressing member 80. The second intake tube 6b extends vertically upward from the pressing member 80. The second intake tube 6b may be integrated with the pressing member 80. An upstream end of the second intake tube 6b is inserted into the intake passage 60 of the first intake tube 6a. A sealing member 68 (e.g., an o-ring) is disposed between the second intake tube 6b and the first intake tube 6a. The second intake tube 6b is configured to move up and down along the first intake tube 6a. The second intake tube 6b is configured to move up and down along with the pressing member 80 moving up and down.

The second intake tube 6b has an intake opening 62 for introducing the fluid into the casing 4. The intake opening 62 is defined above the upper surface 10a of the heater 10. The intake opening 62 is open at a position above the upper surface 10a of the heater 10. The intake opening 62 is defined at a position facing a central part 16 of the heater 10. The central part 16 of the heater 10 is a portion of the heater 10 that is on an inner side of the innermost circumferential portion 14 of the spirally-shaped heater 10. The intake opening 62 opens toward the central part 16 of the heater 10. The intake opening 62 increases in diameter toward the central part 16 of the heater 10. The diameter of the intake opening 62 increases gradually downward. An inner surface of the intake opening 62 is inclined with respect to a longitudinal direction of the intake passage 60. In a variant, the diameter of the intake opening 62 may not increase.

The discharge tube 7 is connected to the upper member 42 of the casing 4. An upstream end of the discharge tube 7 is fixed to the upper member 42 of the casing 4. The discharge tube 7 extends vertically upward from the upper member 42 of the casing 4. The discharge tube 7 may be integrated with the casing 4. The discharge tube 7 comprises a discharge passage 70 configured to discharge the fluid to outside of the casing 4. The discharge passage 70 is in communication with the outer passage 26 inside the casing 4. The discharge passage 70 discharges the fluid from the outer passage 26 to the outside of the casing 4.

### (Operation of Heating Device 2)

In the heating device 2 described above, the fluid is introduced into the casing 4 by the intake tube 6 connected to the casing 4. The fluid is introduced toward the central part 16 of the heater 10. The fluid introduced to the central part 16 of the heater 10 flows from the central part 16 of the heater 10 into both the upper surface-side passage 22 and the lower surface-side passage 24. Such fluid flows radially outward in the radial direction of the heater 10 along the upper surface 10a and the lower surface 10b of the heater 10. The fluid flowing in both the upper surface-side passage 22 and the lower surface-side passage 24 is heated by the heater 10 in a course of flowing in the radial direction of the heater 10.

The fluid heated by the heater 10 is discharged to the outer passage 26 through the connecting passage 28. The fluid discharged into the outer passage 26 is discharged to the outside of the casing 4 through the discharge tube 7 connected to the casing 4.

### Effects

As described above, the heating device 2 according to the embodiment is described. As described above, the heating device 2 comprises: the pressing member 80 (an example for an upper surface-side member) facing the upper surface 10a of the heater 10; the lower surface-side member 48 facing the lower surface 10b of the heater 10; the upper surface-side passage 22 defined between the upper surface 10a of the heater 10 and the pressing member 80; and the lower surface-side passage 24 between the lower surface of the heater 10 and the lower surface-side member 48. The heating device 2 also further comprises: the first spacers 50 disposed between the upper surface 10a of the heater 10 and the pressing member 80 to secure a space between the upper surface 10a of the heater 10 and the pressing member 80; the second spacers 50 disposed between the lower surface 10b of the heater 10 and the lower surface-side member 48 to secure a space between the lower surface 10b of the heater 10 and the lower surface-side member 48; and the elastic member 100 pressing the pressing member 80 toward the heater 10.

According to this configuration, by the elastic member 100 being used to press the pressing member 80 toward the heater 10, for example, even if warpage and/or expansion of the heater 10 occurs when the heater 10 generates heat, they can be corrected. Due to this, the widths of the upper surface-side passage 22 and/or the lower surface-side passage 24 can be suppressed from fluctuating due to the warpage and/or expansion of the heater 10.

In the heating device 2 described above, the heater 10 is spirally shaped. The first spacers 50 extend in the radial direction of the spirally-shaped heater 10 between the upper surface 10a of the heater 10 and the pressing member 80. The second spacers 52 extend in the radial direction of the spirally-shaped heater 10 between the lower surface 10b of the heater 10 and the lower surface-side member 48. According to this configuration, the fluid can be allowed to flow smoothly in the radial direction of the spirally-shaped heater 10 and fluctuations in a flow speed can be suppressed. In addition, heat of the heater 10 can be efficiently transferred to the fluid, and a heat exchange efficiency can be improved.

Although the above embodiment has been described, aspects of the heating device 2 are not limited to the above embodiment. In the following description, detailed descriptions may be omitted for same configurations as those described above.

### Variants

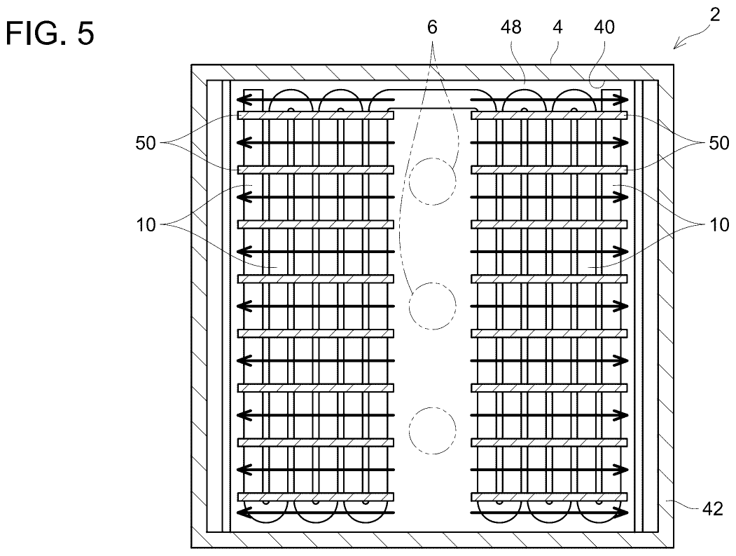

(1) In the above embodiment, the heater 10 is spirally shaped, but the heater 10 is not limited to this configuration. In a variant, as illustrated in FIG. 5, the heater 10 may be configured in a meandering shape in the top view of the heater 10. In this case, the pressing member 80 pressing the heater 10 may, for example, be shaped in a substantially-rectangular shape in the top view (not illustrated).

The plurality of first spacers 50 may extend in parallel to a front-back direction of the meandering heater 10 (see FIG. 5). The plurality of first spacers 50 may be aligned at intervals in the left-right (width) direction of the meandering heater 10 (see FIG. 5).

The heating device 2 may further comprise a plurality of intake tubes 6. In this configuration, the fluid introduced into the casing 4 by the plurality of intake tubes 6 flows in the front-back direction of the meandering heater 10.

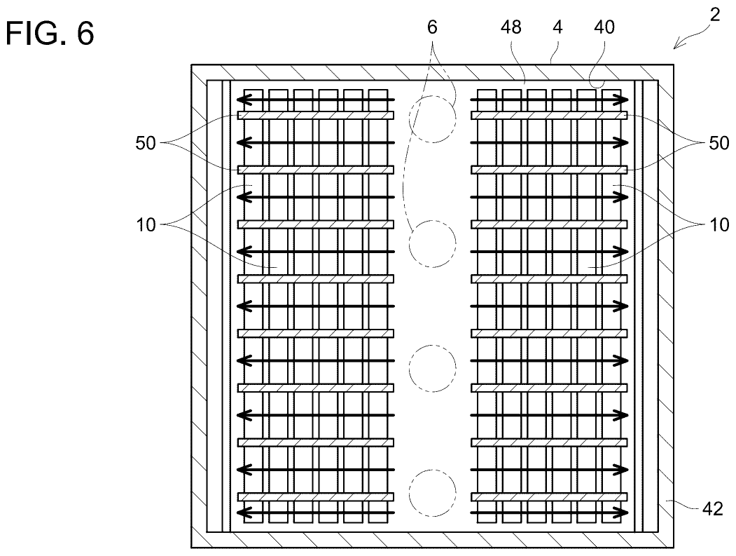

(2) In another variant, as illustrated in FIG. 6, the heaters 10 may be linearly shaped in the top view. The heating device 2 may comprise a plurality of linearly-shaped heaters 10. The plurality of linearly-shaped heaters 10 may be aligned at intervals and may extend in parallel to each other. In this case, the pressing member 80 may, for example, be shaped in a substantially-rectangular shape in the top view (not illustrated).

The plurality of first spacers 50 may be aligned at intervals in the longitudinal direction of the linearly-shaped heaters 10. The plurality of first spacers 50 may extend parallel to a short length direction of the linearly-shaped heaters 10.

The heating device 2 may comprise a plurality of intake tubes 6. In this configuration, the fluid introduced into the casing 4 by the plurality of intake tubes 6 flows in the short length direction of the linearly-shaped heaters 10. According to this configuration, the fluid can be allowed to flow smoothly in the short length direction of the linearly-shaped heaters 10, and fluctuation in the flow speed of the fluid can be suppressed.

(3) In the above embodiment, the pressing member 80 is disposed between the upper surface 10a of the heater 10 and the upper member 42 of the casing 4, and the pressing member 80 faces the upper surface 10a of the heater 10, but is not limited to this configuration. In a variant, the pressing member 80 may be disposed between the lower surface 10b of the heater 10 and the lower member 44 of the casing 4, and the pressing member 80 may face the lower surface 10b of the heater 10. In this configuration, the pressing member 80 is an example for “lower surface-side member”. The upper member 42 is an example for “upper surface-side member”.

In this case, the elastic member 100 may be disposed between the pressing member 80 and the lower member 44 of the casing 4. The elastic member 100 may press the pressing member 80 toward the heater 10 by reaction force of the lower member 44 of the casing 4. This causes the pressing member 80 to press the lower surface 10b of the heater 10 upward.

In this configuration, also, the plurality of first spacers 50 may be disposed between the upper surface 10a of the heater 10 and the upper member 42 of the casing 4, and the plurality of second spacers 52 may be disposed between the lower surface 10b of the heater 10 and the pressing member 80.

(4) The heating device 2 described above may be installed in a vehicle (e.g., electric vehicle, hybrid vehicle, gasoline-driven vehicle, etc.). For example, the heating device 2 may be used to heat medium for an air heating device in a vehicle. According to this configuration, an accuracy of temperature control of fluid (heat medium) used in the vehicle can be improved.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A heating device comprising:
a heater;
an upper surface-side member facing an upper surface of the heater; and
a lower surface-side member facing a lower surface of the heater; and
an upper surface-side passage defined between the upper surface of the heater and the upper surface-side member; and
a lower surface-side passage defined between the lower surface of the heater and the lower surface-side member; and
a first spacer disposed between the upper surface of the heater and the upper surface-side member to secure a space between the upper surface of the heater and the upper surface-side member; and the upper surface-side member; and
a second spacer disposed between the lower surface of the heater and the lower surface-side member to secure a space between the lower surface of the heater and the lower surface-side member; and
an elastic member pressing the upper surface-side member or the lower surface-side member toward the heater.

2. The heating device according to claim 1,
wherein the heater is spirally shaped,
the first spacer extends in a radial direction of the spirally-shaped heater between the upper surface of the heater and the upper surface-side member, and
the second spacer extends in the radial direction of the spirally-shaped heater between the lower surface of the heater and the lower surface-side member.

3. The heating device according to claim 1,
wherein the heater is linearly shaped,
the first spacer extends in a short length direction of the linearly-shaped heater between the upper surface of the heater and the upper surface-side member, and
the second spacer extends in the short length direction of the linearly-shaped heater between the lower surface of the heater and the lower surface-side member.

4. An electric vehicle comprising the heating device according to claim 1.
